(19) United States
(12) Patent Application Publication
(10) Pub. No.: US 2023/0303013 A1
(43) Pub. Date: Sep. 28, 2023

(54) VEHICLE INTERIOR OR EXTERIOR MEMBER AND METHODS OF MANUFACTURING THEREOF

(71) Applicant: Howa Co., Ltd., Kasugaishi, Aichi-ken (JP)

(72) Inventor: Yuichiro INAGAKI, Kasugaishi, Aichi-ken (JP)

(73) Assignee: Howa Co., Ltd., Kasugaishi, Aichi-ken (JP)

(21) Appl. No.: 18/021,088

(22) PCT Filed: Jan. 31, 2022
(86) PCT No.: PCT/JP2022/003507

§ 371 Date: Feb. 13, 2023

(30) Foreign Application Priority Data
Apr. 16, 2021 (JP) 2021-069653

(51) Int. Cl. B60R 13/08; B32B 5/26; D04H 1/46; D04H 3/16; G10K 11/168

(52) U.S. Cl. CPC B60R 13/0815; B32B 5/26; D04H 1/46; D04H 3/16; G10K 11/168

(57) ABSTRACT

A vehicle interior or exterior member includes a base material layer laminated with a sound-absorbing layer. The base material layer is a fiber molded body containing a thermoplastic synthetic resin. The sound-absorbing layer includes a fiber web and a cover layer. The cover layer is a nonwoven fabric containing a thermoplastic synthetic fibers and covers the fiber web. The vehicle interior or exterior member includes a bonding portion, a sound-absorbing portion, and a crimped portion. The bonding portion includes the thermoplastic synthetic fibers on the surface of the sound-absorbing layer in contact with the thermoplastic synthetic resin in the base material layer thermally being bonded to each other. At a position separated from the base material layer, the sound-absorbing portion remains in a fiber web state. The crimped portion includes a portion where the base material layer, the fiber web, and the cover layer are compressed in the thickness direction

### CROSS-REFERENCE TO RELATED APPLICATIONS

The present application is a U.S. National Phase entry of, and claims priority to, PCT Application PCT/JP2022/003507, filed Jan. 31, 2022, which claims priority to Japanese Patent Application No. 2021-069653, filed Apr. 16, 2021, both of which are incorporated herein by reference in their entireties for all purposes.

### BACKGROUND

The present disclosure relates to a vehicle interior or exterior member and a method of manufacturing thereof.

Conventionally, a vehicle interior or exterior member has been made using injection molded materials, polyester fiber materials, glass fiber base materials, or the like. A sound-absorbing material may be attached to the back side of the interior or exterior member for the purpose of quieting the interior of the vehicle. For the sound-absorbing material, for example, a felt made of reclaimed wool or polyester fiber, a felt mainly made of melt-blown fibers of polypropylene, or other suitable material may be used. Spot welding by ultrasonic waves, for example, is used for attaching the sound-absorbing material to the vehicle interior or exterior member.

For example, Japanese Patent Registration No. 6444569 discloses a sound-absorbing material for vehicles which is made by laminating a needle-punched nonwoven fabric containing polyethylene terephthalate and polypropylene with a melt-blown nonwoven fabric containing polypropylene.

Generally, a sound-absorbing material for a vehicle interior or exterior member is laminated with a thin nonwoven fabric for protection against water, sand, wind pressure, or the like. Further, in order to prevent fluffing and fraying of the sound-absorbing material, the edge part may be squeezed by a hot press. In the above case, in the manufacturing process of the interior or exterior member, a pre-processing is required to squeeze the edge part where the sound-absorbing material is cut. In addition, spot-welding is required to bond (weld) the sound-absorbing material to the interior or exterior member, which is performed as a post-processing step. However, there is a concern that the sound-absorbing material could peel away from the interior or exterior member at the welded areas.

Therefore, there is a need for improved vehicle interior or exterior member and a method of manufacturing thereof.

### SUMMARY

A first aspect of the present disclosure is a vehicle interior or exterior member which may include a base material layer and a sound-absorbing layer. The base material layer may be a fiber molded body which contains a thermoplastic synthetic resin and has a sheet-shape. The sound-absorbing layer may include a fiber web and a cover layer. The cover layer is laminated on at least one side of the fiber web. The fiber web may be entangled thermoplastic synthetic fibers and may have a sheet-shape. The cover layer may be a nonwoven fabric which contains thermoplastic synthetic fibers and may have a sheet-shape. The fiber web of the sound-absorbing layer is laminated on one side of the base material layer. The sound-absorbing layer may include a bonding portion, a sound-absorbing portion, and a crimped portion. At the bonding portion, the thermoplastic synthetic fibers of the sound-absorbing layer on the surface in contact with the base material layer and the thermoplastic synthetic resin in the base material layer are thermally bonded to each other. At a part of the sound-absorbing layer separated from the base material layer, the sound-absorbing portion remains in the fiber web state where the thermoplastic synthetic fibers are entangled without having been melted. At the crimped portion the base material layer, the fiber web, and the cover layer were heated in a compressed state in the thickness direction.

According to the first aspect, the vehicle interior or exterior member is bonded at the designated portion of the surface where the base material layer contacts the sound-absorbing layer. Accordingly, the contact surfaces between the base material layer and the sound absorbing layer are bonded over a wide range. Therefore, a vehicle interior or exterior member is integrally formed with the base material layer and the sound-absorbing layer laminated together, and has the bonding portion and the crimped portion. Therefore, the base material layer and sound-absorbing layer are firmly bonded. As a result, the sound-absorbing layer may be prevented from fluffing and fraying, as well as from peeling off from the vehicle interior or exterior member.

### BRIEF DESCRIPTION OF DRAWINGS

FIG. 1 is a diagram schematically showing a base material layer and a sound-absorbing layer of a vehicle interior or exterior member in a laminated state and according to an embodiment.

FIG. 2 is a cross-sectional view schematically showing a state where the base material layer and the sound-absorbing layer are put between an upper die and a lower die of a forming die used in an embodiment of a manufacturing process.

FIG. 3 is a cross-sectional view schematically showing a state where the base material layer and the sound-absorbing layer are pressed and formed by the forming die in an embodiment of a manufacturing process.

FIG. 4 is a cross-sectional view schematically showing the base material layer and the sound-absorbing layer after opening the forming die in an embodiment of the manufacturing process.

FIG. 5 is a diagram schematically showing a vehicle interior or exterior member formed according to the embodiment.

FIG. 6A is a diagram schematically showing a laminated base material layer and a sound-absorbing layer used in the sound absorption coefficient measurement of a vehicle interior or exterior member according to a first embodiment.

FIG. 6B is a diagram schematically showing a laminated base material layer and a sound-absorbing layer used in the sound absorption coefficient measurement of a vehicle interior or exterior member according to a comparative example.

FIG. 7 is a diagram showing the sound absorption performance of the vehicle interior or exterior member for vehicle according to an embodiment and a comparative example.

### DETAILED DESCRIPTION

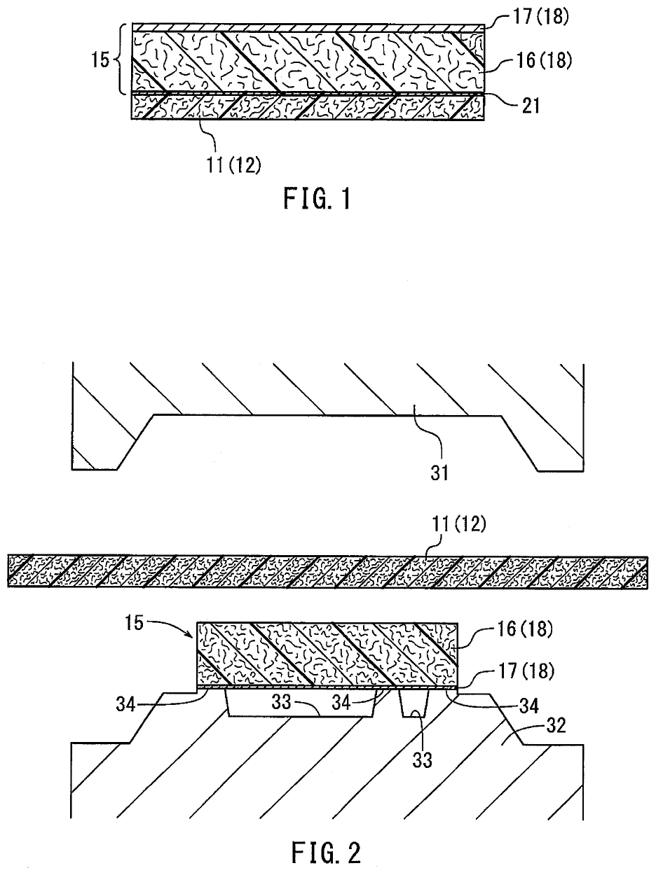

Hereinafter, embodiments of the present disclosure will be described with reference to FIGS. 1 to 7. An undercover, which is a vehicle exterior member, will be described as an example of a vehicle interior or exterior member. An embodiment of a method of manufacturing a vehicle interior or exterior member will also be described. An undercover (which is an embodiment of a vehicle exterior member) of the present embodiment may include a base material layer 11 and a sound-absorbing layer 15, which may be laminated together.

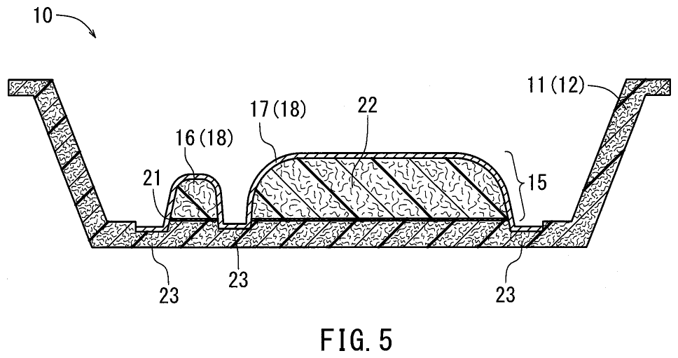

As shown in FIGS. 1 and 5, the base material layer 11 may be a porous fiber material that is made of or includes a thermoplastic synthetic resin 12. The base material layer 11 may be a fiber molded body which is cold formed after heating and has a sheet-shape. The base material layer 11 may include a fiber reinforcement. The base material layer 11 may be produced by known manufacturing methods, for example, a dry method by needle-punching or a wet method such as a paper making method.

The thermoplastic synthetic resin 12 may be, for example, an olefin such as polypropylene, a polyester such as polyethylene terephthalate, or polyamide.

The fiber reinforcement may be, for example, glass fibers, basalt fibers, carbon fibers, or natural fibers such as kenaf or bamboo.

An example of the base material layer 11 is an LWRT fiber base material that includes polypropylene fiber, which is the thermoplastic synthetic resin 12 in this example, used as the binder fiber and glass fiber used as the fiber reinforcement (LWRT=Low Weight Reinforced Thermoplastics). An example of a base material layer 11 that does not include the fiber reinforcement is a needle-punched nonwoven fabric base material (which is an example of a formed nonwoven fabric) that is made of polyethylene terephthalate fibers and binder fibers such as low-melting-point polyester fibers. These base materials may be multi-layered by laminating nonwoven fabrics or films, depending on the need for design and durability.

The sound-absorbing layer 15 has a fiber web 16 and a cover layer 17. The fiber web 16 may contain a thermoplastic synthetic fibers 18 entangled with each other, and have a sheet-shape. The cover layer 17 may be a nonwoven fabric which contains the thermoplastic synthetic fibers 18, and has a sheet-shape. The sound-absorbing layer 15 includes a fiber web 16, which is laminated on one side of the base material layer 11, and the cover layer 17, which is laminated on the fiber web 16.

The thermoplastic synthetic fibers 18 in the fiber web 16 and the cover layer 17 may be selected from the group consisting of polyethylene fiber, polypropylene fiber, polystyrene fiber, polyester fiber, and mixtures thereof. The fiber web 16 is, for example, a laminated felt made from polypropylene fibers or polyester fibers, a needle-punched mat, melt-blown fibers, and mixtures thereof. For example, Thinsulate (Registered Trademark) may be used as the fiber web 16. Polypropylene fibers are preferred because their hydrophobic properties prevent water from penetrating between fibers and because they maintain sound-absorbing properties in use.

The density and/or thickness of the sound-absorbing layer 15 may vary depending on the location where it is attached to the vehicle. When a dense and thick nonwoven fabric is used for the sound-absorbing layer 15, the sound absorbing layer 15 exhibits more sound absorbing performance. The fiber diameter and fiber length of the thermoplastic synthetic fibers 18 used in the fiber web 16 may be selected as appropriate.

The cover layer 17 may be a nonwoven fabric containing the thermoplastic synthetic fibers 18 and may have a sheet-shape. The cover layer 17 may be laminated on the side of the fiber web 16 which is not in contact with the base material layer 11. The fiber web 16 of the sound-absorbing layer 15 is protected by the cover layer 17. The cover layer 17 may be, for example, a spun-bonded nonwoven fabric made of polypropylene. Polyolefins, such as polyethylene and polypropylene, have excellent chemical stability. Therefore, the vehicle exterior member 10, in which the fiber web 16 of the sound-absorbing layer 15 is protected by the cover layer 17, is highly durable against exposure to the atmosphere outside the vehicle, exhaust gases, salt, and corrosive gases. By using a ventilation control nonwoven fabric for the cover layer 17, it is possible to improve the sound-absorbing performance from sound coming from the sound-absorbing layer 15 side.

The cover layer 17 may be laminated on one or both sides of the fiber web 16. By laminating the cover layer 17 on both sides of the fiber web 16, either side of the fiber web 16 can be in contact with the base material layer 11, via the cover layer 17. Thereby, the sound-absorbing layer 15 may be conveniently used for the vehicle exterior member 10 since it can have a shape with its left and right sides reversed.

The sound-absorbing layer 15 has a bonding portion 21 on the side of the sound-absorbing layer 15 in contact with the base material layer 11. In the bonding portion 21, the thermoplastic synthetic resin 12 in the base material layer 11 and the thermoplastic synthetic fibers 18 in the fiber web 16 in contact with the base material layer 11 are melted and then solidified in a heat-bonded state. As a result, the surfaces of the base material layer 11 and the sound-absorbing layer 15 in contact with each other are thermally bonded over a wide area. The bonding portion 21 may be heat-bonded over the entire surface where the base material layer 11 and the sound absorbing layer 15 are in contact with each other. By heat-bonding over a wider area, it is possible to form a vehicle exterior member 10 in which it is more difficult for the sound-absorbing layer 15 to peel off, as compared to the sound-absorbing layer 15 being bonded only in spots.

The sound-absorbing layer 15 may have a sound-absorbing portion 22 and a crimped portion 23. The sound-absorbing portion 22 remains in a fiber web state, where the thermoplastic synthetic fibers 18 are entangled and are not melted together. The crimped portion 23 is a portion of the sound-absorbing layer 15 that is heat-compressed with the base material layer 11. For instance, the fiber web 16 and the cover layer 17 may be compressed in the thickness direction and heat-bonded to the base material layer 11. Specifically, the fiber web 16 and the cover layer 17 of the sound absorbing layer 15 are thermally melted and solidified in a squeezed state. Accordingly, the fiber web 16 and the cover layer 17 are integrally heat-crimped with the base material layer 11. As a result, the thickness of the crimped portion 23 may be made thinner than the thickness of the base material layer 11 at the sound-absorbing portion 22. The crimped portion 23 may be heated by another heat source, such as ultrasonic welding. Thereby, a vehicle exterior member 10 can be formed with a crimped portion 23.

Multiple crimped portions 23 may be provided in spot form or line form at plural portions on the surface on which the base material layer 11 is laminated with the sound-absorbing layer 15. Further, a crimped portion 23 may be provided over the entire periphery of the sound-absorbing layer 15. Therefore, fraying and peeling at the periphery of the sound-absorbing layer 15 may be suppressed, and intrusion of dust, sand, water, or the like may be suppressed. The crimped portion 23 may be provided in spot form or line form at plural portions along the periphery of the sound-absorbing layer 15. Further, the crimped portion 23 may be provided at a plurality of portions in the shape of fine projections. The crimped portion 23 may be provided at any place and depends on the shape of the product and other factors.

Next, a method of manufacturing the vehicle exterior member (which is an example of a vehicle interior or exterior member) of the present embodiment will be described. The method of manufacturing the vehicle exterior member may include a heating step, a bonding step, a forming step, and a crimping step.

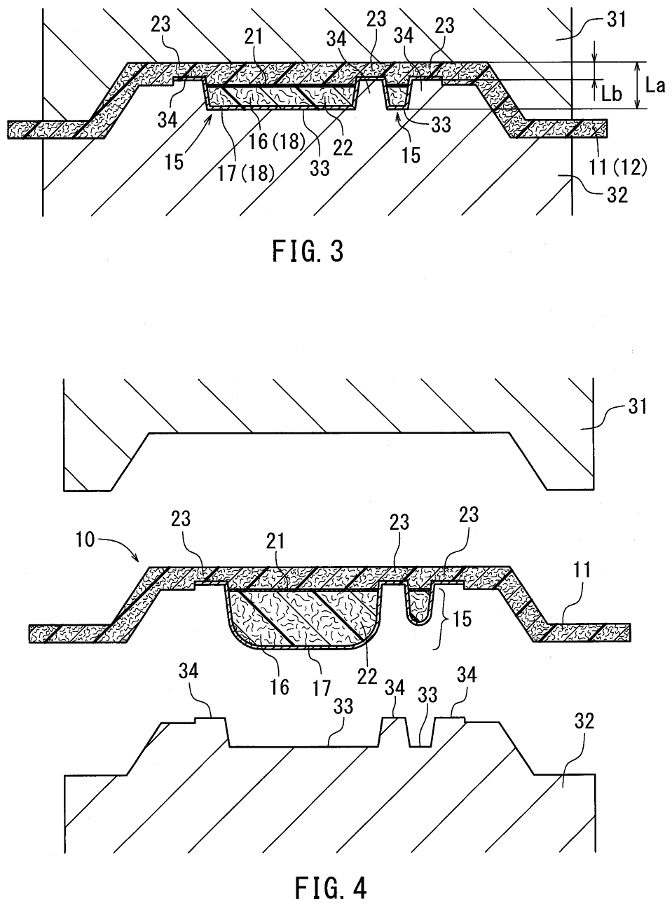

In the present embodiment, a forming die is used for forming the vehicle exterior member 10. The forming die has an upper die 31 and a lower die 32. The lower die 32 is provided with a concave portion 33 and a convex portion 34. A gap La, which is the distance between the upper die 31 and lower die 32 at the concave portion 33, is formed when the forming dies 31, 32 are closed. The gap La is larger than the thickness of the base material layer 11. Another gap Lb, which is the distance between the upper die 31 and the lower die 32 at the convex portion 34, is also formed when the forming dies 31, 32 are closed. This gab Lb is smaller than the thickness of the base material layer 11 (see FIG. 3). The gaps La, Lb between the upper die 31 and the lower die 32 are set so that an appropriate forming pressure is applied, which may be in accordance with the material and basis weight of the base material layer 11 and the sound-absorbing layer 15. For example, if the gap La at the concave portion 33 is made too small, the sound-absorbing layer 15 will be excessively compressed, resulting in reduced sound absorption performance. On the other hand, if the gap La is made too large, the forming pressure between the sound-absorbing layer 15 and the base material layer 11 decreases. Therefore, the gap La is set within a range where an appropriate forming pressure is applied while maintaining the required sound absorption performance.

In the heating step, the base material layer 11 is heated by, for example, a far-infrared heater or an oven.

Next, as shown in FIG. 2, an unheated sound-absorbing layer 15, in which the fiber web 16 and the cover layer 17 are already laminated, is set on the lower die 32 of the forming die. At this time, the cover layer 17 of the sound-absorbing layer 15 is in contact with the lower die 32. The heated base material layer 11 is placed on top of the sound-absorbing layer 15 and is laminated with the sound-absorbing layer 15 while the layers are between the forming dies 31, 32. At the surfaces where the base material layer 11 and the sound-absorbing layer 15 are in contact with each other, the thermoplastic synthetic resin 12 in the base material layer 11 and the thermoplastic synthetic fibers 18 in the fiber web 16, are melted and thermally bonded. The step of heat-bonding the base material layer 11 and the sound-absorbing layer 15 at the surfaces in contact with each other corresponds to an embodiment of the “bonding step” of the present disclosure. The bonding step can be performed together with the forming step, since the sound-absorbing layer 15 is put between the forming dies 31, 32 and the base material layer 11 is laminated in the bonding step.

As shown in FIG. 3, the base material layer 11 and the sound-absorbing layer 15, which are layered, are sandwiched between the forming dies 31, 32 and pressurized while cooling. Thereby, the vehicle exterior member 10 is formed into a designated shape. At the convex portion 34, since the gap Lb between the upper die 31 and the lower die 32 is smaller than the thickness of the base material layer 11, the base material layer 11, the fiber web 16, and the cover layer 17 are compressed in the thickness direction. Therefore, when the gap Lb is sufficiently small, the heat from the heated base material layer 11 is transferred to the fiber web 16 and the cover layer 17. Then, a part of the thermoplastic synthetic fibers 18 in the fiber web 16 and the cover layer 17 is heat-melted. The sound-absorbing layer 15 is thermally pressure-bonded to the base material layer 11 in a squeezed state by the heat-melted thermoplastic synthetic fibers 18, thereby forming the crimped portion 23. The crimped portion 23 may be further crimped by another heat source, such as ultrasonic welding. Thus, by applying a weld with another heat source to the crimped portion 23, the crimped portion 23 can be crimped more firmly. The welding by another heat source may be, for example, infrared welding, electric heater welding, or hot air welding.

The gap La between the upper die 31 and the lower die 32 is larger than the thickness of the base material layer 11 at the concave portion 33. Therefore, the degree of compression of the sound-absorbing layer 15 becomes relatively small, and the heat from the base material layer 11 is transferred less to the sound-absorbing layer 15. Thereby, the thermoplastic synthetic fibers 18 in this portion of the sound-absorbing layer 15 do not melt, and a sound-absorbing portion 22 is formed in which the entangled fiber web state is maintained. As shown in FIG. 4, the sound-absorbing portion 22, which was compressed to fit the gap La between the upper die 31 and the lower die 32 at the concave portion 33, restores its thickness by the repulsive force of the fibers in the fiber web 16 after the forming dies 31, 32 are opened. The thickness of the sound-absorbing portion 22 is thinner than its original thickness. By maintaining the thickness of the sound-absorbing portion 22 above a certain level in this manner, a reduction in sound-absorbing performance may be suppressed.

The dimensions of the gaps La, Lb between the upper die 31 and the lower die 32 may be set as needed. When the gap La at the concave portion 33 of the lower die 32 is reduced, the restoration of the thickness of the sound-absorbing layer 15 becomes smaller and the thickness of the base material layer 11 becomes thinner. On the other hand, when the gap La at the concave portion 33 is increased, the compression of the sound absorbing layer 15 is decreased. However, although the thickness of the sound-absorbing layer 15 and the base material layer 11 can be made thicker if the gap La is larger, the bonding strength of the bonding portion 21 becomes weaker. If the gap La at the concave portion 33 is excessively large, the base material layer 11 cannot be formed into a proper shape due to an insufficient forming pressure being applied to the base material layer 11. Therefore, the dimension of the gap La is set within a range where an appropriate forming pressure is applied while maintaining the required sound absorption performance. When the gap Lb at the convex portion 34 of the lower die 32 is made sufficiently small to compress the sound-absorbing layer 15, a crimped portion 23 is formed where the sound-absorbing layer 15 and the base material layer 11 are tightly pressed together. The adhesive strength of the sound-absorbing layer 15 and the base material layer 11 may be ensured by providing the crimped portion 23 in this manner.

As described above, the step of forming the vehicle exterior member 10 by sandwiching between a pair of forming dies 31, 32 and applying pressure the base material layer 11 and the sound-absorbing layer 15, which become laminated, corresponds to an embodiment of the “forming step” of the present disclosure. The step of compressing the base material layer 11 and the sound-absorbing layer 15 in the thickness direction and forming the crimped portion 23 corresponds to an embodiment of the “crimping step” of the present disclosure. Since an embodiment of the crimping step is the step of forming the crimped portion 23 by sandwiching the base material layer 11 and the sound-absorbing layer between the forming dies 31, 32, the crimping step can be performed together with the forming step. Therefore, the step of heat-bonding the sound-absorbing layer 15 to the base material layer 11, crimping the sound-absorbing layer 15 and to the base material layer 11 by squeezing the sound-absorbing layer 15, and forming the vehicle exterior member 10 can be performed simultaneously.

According to the manufacturing method of the vehicle exterior member of the present embodiment, it is possible to obtain a vehicle exterior member 10 in which the base material layer 11 and the sound-absorbing layer 15 are integrally formed. As shown in FIG. 5, the vehicle exterior member 10 is attached to a vehicle as an undercover in a state where the top and bottom orientation reversed.

According to the vehicle exterior member 10 of the above embodiment, the base material layer 11 and the sound-absorbing layer 15 are laminated and their surfaces are heat-bonded with each other at one or more designated portion. The base material layer 11 is a fiber molded body which contains a thermoplastic synthetic resin 12 and has a sheet-shape. The sound-absorbing layer 15 includes a fiber web 16 which contains thermoplastic synthetic fibers 18 and has a sheet-shape. The sound-absorbing layer 15 also includes the cover layer 17. At the bonding portion 21, the thermoplastic synthetic fibers 18 at the surface of the sound-absorbing layer 15 in contact with the base material layer 11 and the thermoplastic synthetic resin 12 in the base material layer 11 are melted and then solidified in a heat-bonded state. As a result, the contact surface between the base material layer 11 and the sound-absorbing layer 15 is bonded over a wide area. In the vehicle exterior member 10, one or more crimped portion 23 is formed by heat-compressing the base material layer 11, the fiber web 16, and the cover layer 17 in a compressed state in the thickness direction. In addition, the sound-absorbing portion 22, which remains in a fiber web state where the thermoplastic synthetic fibers 18 are entangled and have not been melted, is formed. A product is formed in which the base material layer 11 and the sound-absorbing layer 15 are firmly heat-bonded due to having at least one bonding portion 21 and crimped portion 23. As a result, fluffing and fraying of the sound-absorbing layer 15 and peeling of the sound-absorbing layer 15 from the vehicle exterior member 10 may be prevented.

The vehicle exterior member 10 is provided with crimped portions 23 in point form or line form at a plurality of portions on the surface of the vehicle exterior member 10 on which the base material layer 11 is laminated with the sound-absorbing layer 15. By increasing the number of crimped portions 23 in this way, the function of preventing the sound-absorbing layer 15 from fraying and peeling may be improved. The adhesive strength of the bonding portion 21 of the member may be maintained while adjusting the degree of compression in the sound-absorbing portion 22. For example, by reducing the degree of compression of the sound-absorbing portion 22, for instance by increasing the gap La between the forming dies 31, 32 at the concave portion 33, the thickness of the base material layer 11 and the sound-absorbing layer 15 may be made thicker. In this case, since a fewer number of the thermoplastic synthetic fibers 18 in the sound-absorbing layer 15 are melted, the adhesive strength of the bonding portion 21 of the sound-absorbing portion 22 is reduced, but a decrease in the sound absorbing coefficient may be suppressed. On the other hand, since the base material layer 11 and the sound-absorbing layer 15 are suitably compressed and thermally crimped at the crimped portion 23, a sufficient adhesive strength can be ensured.

By providing a plurality of crimped portions 23 in a point form or line form along the periphery of the sound-absorbing layer 15, the sound-absorbing layer 15 is more firmly heat-bonded to the base material layer 11 at the periphery. Therefore, fraying and peeling at the edge of the sound-absorbing layer 15 may be suppressed, thereby strengthen the product's protection against dust, sand, water, and the like. Further, by providing the crimped portion 23 along the entire periphery of the sound-absorbing layer 15, it is possible to prevent the fiber from spilling out from the periphery of the sound absorbing layer 15.

Regarding the manufacturing process of the vehicle exterior member 10 of the above embodiment, in the bonding step, the pre-heated base material layer 11, which includes a thermoplastic synthetic resin 12, and the sound-absorbing layer 15, which includes a thermoplastic synthetic fibers 18, are pressed from both sides by the forming dies 31, 32 in a layered state. Due to the heat from the base material layer 11, the thermoplastic synthetic resin 12 in the base material layer 11 and the thermoplastic synthetic fibers 18 in the sound absorbing layer 15 are thermally bonded to each other. Therefore, the base material layer 11 and the sound-absorbing layer 15 are bonded to each other over a wide area on the surfaces in contact with each other. In the forming step, the base material layer 11 and the sound-absorbing layer 15 are sandwiched between a pair of forming dies 31, 32 and cold-formed into the designated shape. Further, in the crimping step, the base material layer 11, the fiber web 16, and the cover layer 17 are compressed in the thickness direction at the designated portion in the sound-absorbing layer 15. At the compressed portion, a part of the thermoplastic synthetic fibers 18 in the sound absorbing layer 15 is squeezed and melted and by the heat from the base material layer 11, thereby forming the crimped portion 23. By performing these steps together, the step of bonding the sound-absorbing layer 15 to the base material layer 11 and the step of squeezing the sound-absorbing layer 15 can be performed at the same time as the step of forming the vehicle exterior member 10. In addition, it is possible to form a vehicle exterior member 10 in which the sound-absorbing layer 15 does not easily peel off.

The lower die 32 of the forming die has a concave portion 33 and a convex portion 34. At the concave portion 33, a gap La between the upper die 31 and the lower die 32 when the forming dies 31, 32 are closed is larger than the thickness of the base material layer 11. At the convex portion 34, the gap Lb is smaller than the thickness of the base material layer 11. When the base material layer 11 and the sound-absorbing layer 15 are sandwiched between the forming dies 31, 32, the sound-absorbing layer 15 is compressed together with the base material layer 11 at the portion where it contacts the convex portion 34. Therefore, a part of the thermoplastic synthetic fibers 18 in the sound-absorbing layer 15 is melted by the heat from the base material layer 11, thereby forming the crimped portion 23. At the portion where the sound absorbing layer 15 is in contact with the concave portion 33, the compression of the sound-absorbing layer 15 is relatively small, and the heat from the base material layer 11 is not easily transferred to the sound-absorbing layer 15. Therefore, a sound-absorbing portion 22, in which the thermoplastic synthetic fibers 18 contained in the sound-absorbing layer 15 do not melt and the entangled fiber web state is maintained, is formed. After the pair of forming dies 31, 32 are opened, the sound-absorbing portion 22 restores at least a part of its thickness due to the repulsive force of the fiber contained in the fiber web 16. As a result, the required thickness of the sound-absorbing layer 15 may be maintained.

The dimension of the gaps La, Lb between the upper die 31 and the lower die 32 are set according to, for example, the material and basis weight of the base material layer 11 and the sound absorbing layer 15. By setting the dimension of the gaps La, Lb within an appropriate range, it is possible to prevent the sound-absorbing layer 15 from being excessively compressed, which would result in a reduced sound absorption performance, as well as applying an appropriate forming pressure to the base material layer 11. Therefore, it is possible to form a vehicle exterior member 10 that maintain sufficient sound absorption performance and crimping strength.

The crimped portion 23 of the vehicle exterior member 10 may be further welded by another heat source, such as ultrasonic welding, in order to further strengthen the crimping strength between the base material layer 11 and the sound-absorbing layer 15. Thereby, even if the base material layer 11 and the sound-absorbing layer 15 have variations in their basis weight and shape, it is possible to suppress the occurrence of areas where the crimping strength is insufficient.

According to the configuration and manufacturing process of the vehicle exterior member 10 of the above embodiment, it is possible to provide the vehicle exterior member 10 in which the base material layer 11 and the sound absorbing layer 15 of the vehicle exterior member 10 are formed as a single piece and the layers do not easily peel apart, without the need for pre-treatment of the sound absorbing layer 15 or post-processing of the formed exterior material.

Hereinafter, the present disclosure will be specifically described according to some embodiments and a comparative example.

Now, a First Embodiment will be described. As a base material layer 11, a vehicle undercover material (basis weight of 1400 gsm), which is a multi-layered fiber base material in which a needle-punched nonwoven fabric is bonded to a fiber base material made by needle punching glass fibers with polypropylene fibers, is used. As a sound-absorbing layer 15, a sound-absorbing material (basis weight of 230 gsm, and a thickness of approximately 25 mm) mainly composed of melt-blown polypropylene fibers is used. Both sides of the sound-absorbing layer 15 are laminated with a spun-bonded nonwoven fabric made of polypropylene, which acts as the cover layer 17. Only the base material layer 11 is heated to a surface temperature of 210° C. The unheated sound absorbing layer 15 is laminated with the heated base material layer 11, and they are then compressed and formed at room temperature. The crimped portions 23 are provided at four positions. The gap La between the upper die 31 and the lower die 32 of the forming die is set to 8 mm at the concave portion 33, and the gap Lb is set to 2 mm at the convex portion 34. After the vehicle exterior member 10 is formed, the sound-absorbing portion 22 has a total thickness of approximately 20 mm (approximately 5 mm of which is the base material layer 11 and approximately 15 mm of which is the sound absorbing layer 15). The crimped portion 23 has a total thickness of 2 mm, since the base material layer 11 and the sound-absorbing layer were compressed, so that the crimped portion 23 is appropriately crimped.

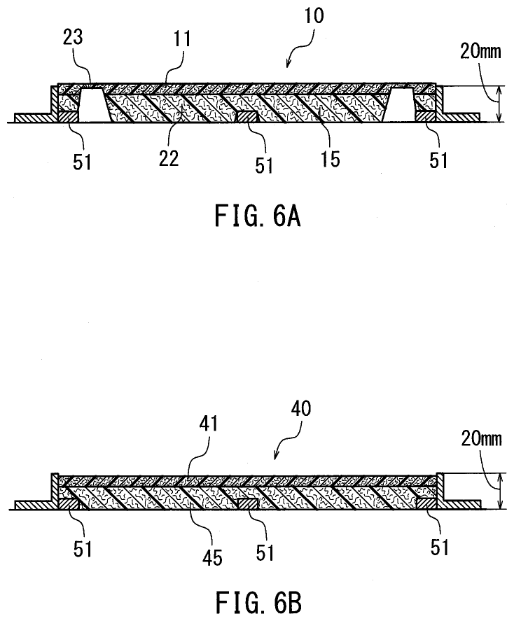

Next, a Comparative Example will be described. As a base material layer 41, the same vehicle undercover material as in the First Embodiment is used. The base material layer 41 is formed with a thickness of 7 mm. As a sound-absorbing layer 45, a sound-absorbing material (basis weight of 150 gsm, thickness of approximately 13 mm) consisting mainly of melt-blown fibers made of polypropylene is used (see FIG. 6B). A spun-bonded nonwoven fabric made of polypropylene is laminated as the cover layer 17 on both sides of the sound-absorbing layer 45. The sound-absorbing layer 45 is only laminated on the base material layer 41 and does not have a crimped portion. The laminated fiber layer 40 (the sound-absorbing section) has a total thickness of approximately 20 mm (7 mm of which is the base material layer 41 and approximately 13 mm of which is the sound absorbing layer 45).

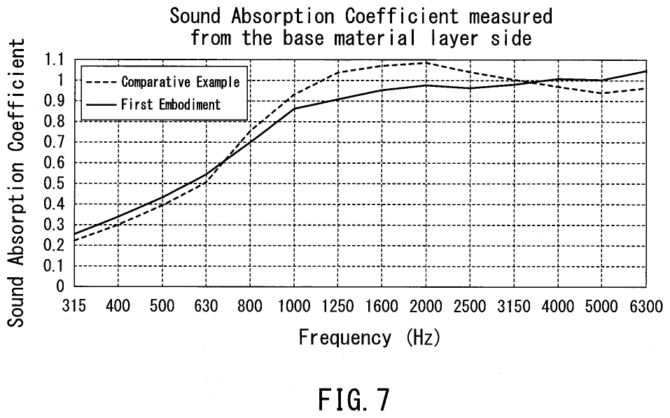

The sound absorption coefficient of the vehicle exterior member 10 formed according to the first embodiment and the fiber layer 40 formed according to the comparative example were measured and compared. Specifically, assuming the evaluation of the sound absorption performance of road noise as an undercover, the sound absorption coefficient is measured from the base material layers 11, 41 side. The sound absorption coefficient is measured by the reverberant sound absorption coefficient according to the standard of JIS A 1409. As shown in FIGS. 6A and 6B, the surface of the base material layers 11, 41 is arranged to a position at a height of 20 mm above the floor by spacers 51. FIG. 7 shows the respective sound absorption coefficients of the first embodiment and the comparative example. The sound absorption coefficient for each frequency of the first embodiment changes with the same tendency as that of the comparative example in the frequency range of 315-2500 Hz. The first embodiment shows a higher sound absorption coefficient than the comparative example in the frequency ranges of 315-630 Hz and 4000-6300 Hz. The sound absorption coefficient of the first embodiment is only up to 13% lower than that of comparative example in the frequency range of 800-3150 Hz, and is only up to 8% lower than that of comparative example in the frequency range of 800-1000 Hz. Thus, a significant decrease in the sound-absorbing performance of the vehicle exterior member 10 according to the first embodiment is suppressed.

Next, a Second Embodiment will be described. As the base material layer 11, a vehicle undercover material (basis weight of 1200 gsm), which is a needle-punched nonwoven fabric base material (a formed nonwoven fabric) made of polyethylene terephthalate fiber and a binder fiber such as a low-melting-point polyester fiber. As the sound-absorbing layer 15, a felt (basis weight of 340 gsm, and a thickness of approximately 20 mm), which is composed of melt-blown polypropylene fibers and polyethylene terephthalate fibers, is used. As the cover layer 17, a spun-bonded nonwoven fabric made of polypropylene is laminated on both surfaces of the sound absorbing layer 15. Only the base material layer 11 is heated to a surface temperature of 210° C. The unheated sound absorbing layer 15 is laminated with the heated base material layer 11, and they are then compressed and formed at room temperature. The crimped portions 23 are provided at four positions. The gaps La between the upper die 31 and the lower die 32 of the forming die is set to 5.5 mm at the concave portion 33, and the gap Lb is set to 1.5 mm at the convex portion 34. After the vehicle exterior member 10 is formed, the sound-absorbing portion 22 has a total thickness of approximately 16.5 mm (approximately 3.5 mm of which is the base material layer 11 and approximately 13 mm of which is the sound absorbing layer 15). The crimped portion 23 has a total thickness of 1.5 mm after the base material layer 11 and the sound-absorbing layer 15 have been compressed, so that the crimped portion 23 is appropriately crimped.

Next, a Third Embodiment will be described. As the base material layer 11 and the sound-absorbing layer 15, the vehicle undercover material (basis weight of 1200 gsm), which has the same composition as that of the second embodiment, and a felt (basis weight of 340 gsm, and a thickness of approximately 20 mm) is used. As the cover layer 17, a spun-bonded nonwoven fabric made of polypropylene is laminated on both surfaces of the sound absorbing layer 15. Only the base material layer 11 is heated to a surface temperature of 210° C. The unheated sound-absorbing layer 15 is laminated with the heated base material layer 11, and they are then compressed and formed at room temperature. The crimped portions 23 are provided at four positions. The gaps La between the upper die 31 and the lower die 32 of the forming die is set to 4 mm at the concave portion 33, and the gap Lb is set to 1.5 mm at the convex portion 34. After the vehicle exterior member 10 is formed, the sound-absorbing portion 22 has a total thickness of approximately 12.5 mm (approximately 2.5 mm of which is the base material layer 11 and approximately 10 mm of which is the sound-absorbing layer 15). The crimped portion 23 has a total thickness of 1.5 mm after the base material layer 11 and the sound-absorbing layer 15 have been compressed, so that the crimped portion 23 is appropriately crimped.

The vehicle interior or exterior member of the present disclosure is not limited to the appearance and configuration described in the above embodiments, and can be implemented in various other forms by various changes, additions, deletions, and combinations of configurations without departing from the scope of the present disclosure.

The vehicle interior or exterior member according to the above embodiments may be either a vehicle interior member or vehicle exterior member. A vehicle interior member of the present disclosure may be applied, for example, to luggage trims, door trims, rear parcel shelves, deck boards, trunk trims, pillar garnishes, or roof trims. A vehicle exterior member of the present disclosure may be applied, for example, to vehicle underfloor undercovers (engine undercovers, floor undercovers, etc.) or wheel house protectors.

A second aspect of the present disclosure is a vehicle interior or exterior member according to the first aspect, wherein the crimped portion of the vehicle interior or exterior member is provided in spot form or line form at plural portions on the surface of the sound-absorbing layer laminated with the base material layer.

According to the second aspect, by increasing the number of crimped portions, the performance of preventing the sound-absorbing layer from fraying or peeling from the vehicle interior or exterior member may be improved. The bonding strength of the bonding portion of the product may be maintained while adjusting the degree of compression in the sound-absorbing portion. For example, by reducing the degree of compression of the sound-absorbing portion, the thickness of the base material layer and the sound-absorbing layer may be made thicker. In this case, although the bonding strength of the bonding portion in the sound-absorbing portion is lower because a fewer number of the thermoplastic synthetic fibers in the sound-absorbing layer are melted, a reduction in the sound absorption coefficient may be further suppressed. On the other hand, the base material layer and sound-absorbing layer are suitably compressed and heat-compressed at the crimped portion, thereby ensuring the bonding strength.

A third aspect of the present disclosure is a vehicle interior or exterior member according to the first aspect, wherein the crimped portion of the vehicle interior or exterior member is provided in spot form or line form at plural portions along the periphery of the sound-absorbing layer, or over the entire periphery of the sound-absorbing layer.

According to the third aspect, the fibers of the sound-absorbing layer are prevented from spilling out of the periphery of the sound-absorbing layer. Further, this prevents fraying and peeling from the periphery of the sound-absorbing layer and enhances protection against dust, sand, water or the like.

A fourth aspect of the present disclosure is a method of manufacturing a vehicle interior or exterior member, which may include a heating step, a bonding step, a forming step, and a crimping step. In the heating step, a base material layer is heated. The base material layer may be a fiber molded body which contains a thermoplastic synthetic resin and may have a sheet-shape. In the bonding step, an unheated sound-absorbing layer is layered with the heated base material layer. Then, the thermoplastic synthetic resin in the base material layer and the thermoplastic synthetic fibers in the fiber web are thermally bonded on the surfaces in contact with each other. The sound-absorbing layer is layered with a cover layer on at least one side of the fiber web. The cover layer is a nonwoven fabric which contains the thermoplastic synthetic fibers and has a sheet-shape. The fiber web contains entangled thermoplastic synthetic fibers and has a sheet-shape. In the forming step, the laminated base material layer and the sound-absorbing layer are sandwiched in a forming die, the forming die having an upper die and a lower die. The sandwiched layers are pressurized and cooled into form. In the crimping step, the sound-absorbing layer is crimped to the base material layer by compressing and heat-crimping the base material layer, the fiber web, and the cover layer in the thickness direction to form a crimped portion. The bonding step and the crimping step can be performed together with the forming step.

According to the fourth aspect, in the bonding step, the pre-heated base material layer including the thermoplastic synthetic resin and the sound-absorbing layer including the thermoplastic synthetic fibers are pressed from both sides by the forming die in a layered state. Due to the heat from the base material layer, the thermoplastic synthetic resin in the base material layer and the thermoplastic synthetic fibers in the sound-absorbing layer are thermally bonded to each other. Therefore, the base material layer and the sound-absorbing layer are bonded to each other over a wide area of the surfaces that are in contact with each other. Further, in the forming step, the base material layer and the sound-absorbing layer are sandwiched between a pair of forming dies, so that the base layer and the sound-absorbing layer are formed into a designated shape. Furthermore, in the crimping step, the base material layer, the fiber web, and the cover layer are compressed in the thickness direction at one or more designated position. Thereby, some of the thermoplastic synthetic fibers in the sound-absorbing layer are melted by the heat from the base material layer and squeezed by the forming die, thereby forming the crimped portion. By performing these steps together, the bonding step of the sound-absorbing layer to the base material layer and the crimping step of the sound-absorbing layer can be performed simultaneously in the forming step of the vehicle interior or exterior member. In addition, it is possible to form a vehicle interior or exterior member in which the sound-absorbing material does not easily peel off.

A fifth aspect of the present disclosure is a method of manufacturing a vehicle interior or exterior member according to the fourth aspect, wherein one of the pair of forming dies has a concave portion and a convex portion. A gap is formed between the surfaces of the upper die and the lower die facing each other when a pair of forming dies are closed. The gap at the concave portion is larger than the thickness of the base material layer. The gap at the convex portion is smaller than the thickness of the base material layer. The sound-absorbing portion which remains in the fiber web state, where the thermoplastic synthetic fibers are entangled without having been melted, is formed at the concave portion, and the crimped portion is formed at the convex portion. After the pair of forming dies is opened, the sound-absorbing portion is restored to a thickness greater than that of the crimped portion by the resilience of the fiber in the fiber web.

According to the fifth aspect, when the base material layer and the sound-absorbing layer, which are being laminated, are sandwiched from both sides by the forming die, the sound absorbing layer is compressed together with the base material layer at a portion in contact with the convex portion. Therefore, the heat from the base material layer melts more of thermoplastic synthetic fibers in the sound-absorbing layer, thereby forming the crimped portion. Since the compression of the sound-absorbing layer is relatively small at the portion where the sound-absorbing layer is in contact with the concave portion, it is difficult for the heat from the base material layer to transfer thereto. Therefore, a fewer number of the thermoplastic synthetic fibers in the sound-absorbing layer melt, and the sound-absorbing portion is formed in which the entangled fiber web state is maintained. As a result, after opening the pair of forming dies, the thickness of the sound-absorbing portion is restored by the resilience of the fiber in the fiber web, thereby maintaining the required thickness of the sound-absorbing material even after forming the product.

A sixth aspect of the present disclosure is a method of manufacturing a vehicle interior or exterior member according to the fourth aspect, wherein the crimped portion is further welded using a heat source other than that used in the crimping step.

According to the sixth aspect, since the crimped portion of the vehicle interior or exterior member is further heated and welded, the crimped portion at which the base material layer and the sound-absorbing layer are crimped may be more firmly crimped.

The configuration and/or steps of the present disclosure may result in a vehicle interior or exterior member without performing a pre-treatment of the sound-absorbing material or a post-processing after forming of the interior or exterior member. The interior or exterior member, which has the sound-absorbing material, is integrally formed and it is difficult for the sound-absorbing material to peel off.

The various examples described above in detail with reference to the attached drawings are intended to be representative of the present disclosure and are thus non-limiting embodiments. The detailed description is intended to teach a person of skill in the art to make, use, and/or practice various aspects of the present teachings, and thus does not limit the scope of the disclosure in any manner. Furthermore, each of the additional features and teachings disclosed above may be applied and/or used separately or with other features and teachings in any combination thereof, to provide an improved vehicle interior or exterior member and methods of manufacturing thereof, and/or methods of using the same.

What is claimed is:

1. A vehicle interior or exterior member, comprising:
a base material layer which is a fiber molded body containing a thermoplastic synthetic resin; and
a sound-absorbing layer,
wherein the sound-absorbing layer comprises:
a fiber web which contains entangled thermoplastic synthetic fibers;
a cover layer which is a nonwoven fabric containing thermoplastic synthetic fibers, and is laminated on at least one side of the fiber web;
a bonding portion in which the thermoplastic synthetic fibers on a surface of the sound-absorbing layer are thermally bonded with the thermoplastic synthetic resin in the base material layer;
a sound-absorbing portion in a fiber web state where the thermoplastic synthetic fibers at a position separated from the base material layer are entangled and are not melted together; and
a crimped portion in which the base material layer, the fiber web, and the cover layer are compressed in a thickness direction.

2. The vehicle interior or exterior member according to claim 1, further comprising a second crimped portion, wherein the crimped portion and the second crimped portion are provided in a spot form or a line form.

3. The vehicle interior or exterior member according to claim 2, wherein the crimped portion and the second crimped portion are provided in a spot form or a line form at a periphery of the sound-absorbing layer.

4. A method of manufacturing a vehicle interior or exterior member, comprising the steps of:
heating a base material layer, which is a fiber molded body containing a thermoplastic synthetic resin;
bonding the thermoplastic synthetic resin in the base material layer and the thermoplastic synthetic fibers in the fiber web on the surface where the non-heated sound absorbing layer and the heated base layer are in contact with each other;
forming, by utilizing pressure and cooling, the base material layer and the sound-absorbing layer by sandwiching the base material layer and the sound-absorbing layer between an upper forming die and a lower forming die; and
crimping the sound-absorbing layer with the base material layer by compressing and heat-crimping the base material layer, the fiber web, and the cover layer in the thickness direction to form a crimped portion,
wherein:
the sound-absorbing layer comprises:
a fiber web which contains entangled thermoplastic synthetic fibers; and
a cover layer which is a nonwoven fabric containing thermoplastic synthetic fibers, and is laminated on at least one side of the fiber web, and
the bonding step and the crimping step are configured to be performed together with the forming step.

5. The method of manufacturing the vehicle interior or exterior member according to claim 4, wherein:
one of the upper forming die or the lower forming die has a concave portion and a convex portion and a gap between the upper forming die and the lower forming die at the concave portion is larger than a thickness of the base material layer and a gap between the upper forming die and the lower forming die at the convex portion is smaller than the thickness of the base material layer when the upper forming die and the lower forming die are in a closed position;
a portion of the sound-absorbing layer which remains in a fiber web state, where the thermoplastic synthetic fibers are entangled and have not been fully melted together, is formed at the concave portion;
a crimped portion is formed at the convex portion; and
a sound-absorbing portion is restored to a thickness greater than that of the crimped portion due to the resilience of the fibers in the fiber web after the upper forming die and the lower forming die are no longer in the closed position.

6. The method of manufacturing the vehicle interior or exterior member according to claim 4, further comprising a second crimping step of crimping by a heat source other than heat from the heated base material layer.

7. The vehicle interior or exterior member according to claim 1, wherein the crimped portion is provided over the entire periphery of the sound-absorbing layer.

8. The vehicle interior or exterior member according to claim 1, wherein a thickness of the crimped portion in the thickness direction is thinner than a thickness of the base material layer.
